(19) United States
(12) Patent Application Publication
(10) Pub. No.: US 2020/0270368 A1
(43) Pub. Date: Aug. 27, 2020

(54) CELLULOSE MIXED ESTER AND MOLDED ARTICLE OF SAME

(71) Applicant: Daicel Corporation, Osaka-shi, Osaka (JP)

(72) Inventors: Tomohiro HASHIZUME, Tokyo (JP); Hiroyuki MATSUMURA, Tokyo (JP); Tohru SHIBATA, Tokyo (JP); Hiroshi KOYAMA, Tokyo (JP); Mitsuru OHNO, Tokyo (JP)

(73) Assignee: Daicel Corporation, Osaka-shi, Osaka (JP)

(21) Appl. No.: 16/646,438

(22) PCT Filed: Aug. 22, 2018
(86) PCT No.: PCT/JP2018/031009

§ 371 Date: Mar. 11, 2020

(30) Foreign Application Priority Data
Oct. 3, 2017 (JP) 2017-193183

(51) Int. Cl. C08B 3/16; B01D 71/18

(52) U.S. Cl. CPC C08B 3/16; B01D 71/18

(57) ABSTRACT

Provided is a semipermeable membrane with high chlorine resistance and high alkali resistance. A cellulose mixed ester represented by a structural formula of General Formula (I), wherein when X is an aromatic acyl group, a degree of substitution is from 2.91 to 3.0; the aromatic acyl group includes a benzoyl group (A) that may include a substituent, and an aromatic acyl group (B) containing a carboxyl group or a salt of a carboxyl group; when the degree of substitution is 3.0, a degree of substitution of the benzoyl group (A) that may include a substituent is from 2.4 to 2.95, and a degree of substitution of the aromatic acyl group (B) containing a carboxyl group or a salt of a carboxyl group is from 0.05 to 0.6; and in General Formula (I), all or part of Xs are aromatic acyl groups; when part of Xs are aromatic acyl groups, the remainder represents a hydrogen atom or an alkyl group; and n represents an integer from 20 to 20000.

### TECHNICAL FIELD

The present invention relates to a cellulose mixed ester that can be used as a semipermeable membrane, a film, a sheet, or the like, and a molded article made of the cellulose mixed ester.

### BACKGROUND ART

Water treatment technology using a membrane made of cellulose acetate as a membrane material is known (JP 5471242 B and JP 5418739 B). JP 5471242 B describes an invention of a water treatment method using a chlorine resistant RO membrane (paragraph [0031]) made of cellulose triacetate and the like. JP 5418739 B describes an invention of a hollow fiber semipermeable membrane for a forward osmosis treatment made of cellulose acetate. Paragraph [0017] describes that cellulose acetate is resistant to chlorine, which is a bactericide, and cellulose triacetate is preferred in terms of durability.

JP 10-52630 A describes an invention of a method for producing a stable and storable cellulose dialysis membrane in the form of a flat membrane, a tubular membrane, or a hollow fiber membrane for a low flux, medium flux, or high flux range. The use of modified cellulose as a membrane-forming component is also described. JP 2014-513178 T describes an invention of a position-selectively substituted cellulose ester containing a plurality of alkylacyl substituents and a plurality of arylacyl substituents and an optical film.

### SUMMARY OF INVENTION

An object of the present invention is to provide a cellulose mixed ester and a molded article obtained from the same.

The present invention provides a cellulose mixed ester (hereinafter, referred to as a first cellulose mixed ester) represented by a structural formula of General Formula (I),

wherein when X is an aromatic acyl group, a degree of substitution is from 2.91 to 3.0;

the aromatic acyl group includes a benzoyl group (A) that may include a substituent, and an aromatic acyl group (B) containing a carboxyl group or a salt of a carboxyl group; and

a degree of substitution of the benzoyl group (A) that may include a substituent is from 2.4 to 2.95, and a degree of substitution of the aromatic acyl group (B) containing a carboxyl group or a salt of a carboxyl group is from 0.05 to 0.6.

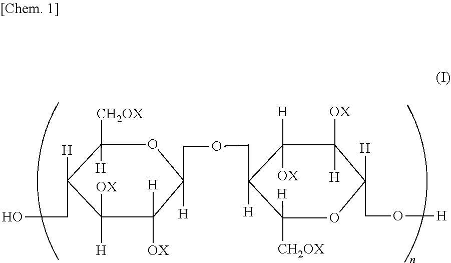

In General Formula (I), all or part of Xs are aromatic acyl groups; when part of Xs are aromatic acyl groups, the remainder represents a hydrogen atom or an alkyl group; and n represents an integer from 20 to 20000.

In addition, the present invention provides a cellulose mixed ester (hereinafter, referred to as a second cellulose mixed ester) represented by a structural formula of General Formula (I),

wherein when X is an aromatic acyl group, a degree of substitution is from 1.8 to 2.9;

the acyl group includes a benzoyl group (A) that may include a substituent, and an aromatic acyl group (B) containing a carboxyl group or a salt of a carboxyl group;
a degree of substitution of the benzoyl group (A) that may include a substituent is from 1.75 to 2.85, and a degree of substitution of the aromatic acyl group (B) containing a carboxyl group or a salt of a carboxyl group is from 0.05 to 0.6; and

when X is a hydrogen atom, a degree of substitution corresponding to a hydroxyl group is from 0.1 to 1.2.

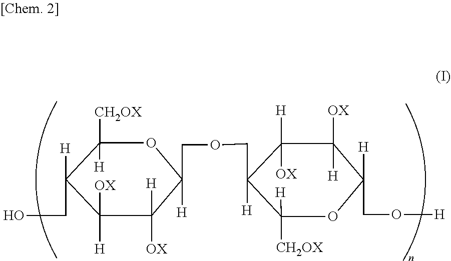

In General Formula (I), part of Xs are aromatic acyl groups, the remainder represents a hydrogen atom, and n represents an integer from 20 to 20000.

The molded article made of the cellulose mixed ester according to an embodiment of the present invention has higher chlorine resistance and higher alkali resistance than those of cellulose triacetate membranes.

### BRIEF DESCRIPTION OF DRAWINGS

FIG. 1 is a diagram illustrating a method for producing a porous filament in Examples.

### DESCRIPTION OF EMBODIMENTS

### First Cellulose Mixed Ester

A first cellulose mixed ester according to an embodiment of the present invention is a cellulose mixed ester represented by a structural formula of General Formula (I) below.

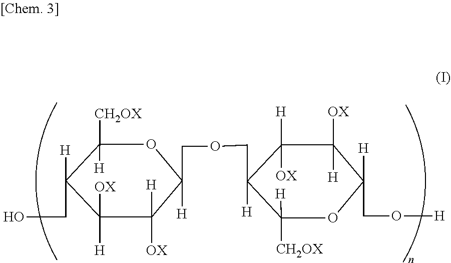

In General Formula (I), all or part of Xs are aromatic acyl groups; when part of Xs are aromatic acyl groups, the remainder represents a hydrogen atom or an alkyl group; and n represents an integer from 20 to 20000.

When X in the first cellulose mixed ester is an aromatic acyl group, a degree of substitution is from 2.91 to 3.0. The “degree of substitution” is an average value of the number of the aromatic acyl group added to three hydroxy groups in the glucose ring.

When the degree of substitution of the aromatic acyl group is 3.0, all of Xs are aromatic acyl groups. When the degree of substitution of the aromatic acyl group is less than 3.0, the remainder of X is a hydrogen atom or an alkyl group.

n represents an integer from 20 to 20000, preferably an integer from 40 to 10000, and more preferably an integer from 60 to 8000.

When X is an aromatic acyl group, and the degree of substitution of the aromatic acyl group is 3.0, the aromatic acyl group includes a benzoyl group (A) that may include a substituent, and an aromatic acyl group (B) containing a carboxyl group or a salt of a carboxyl group.

The degree of substitution of the benzoyl group (A) that may include a substituent is from 2.4 to 2.95 and preferably from 2.5 to 2.9. To improve the chlorine resistance of the cellulose mixed ester according to an embodiment of the present invention, the benzoyl group (A) that may include a substituent preferably has higher degree of substitution.

The degree of substitution of the aromatic acyl group (B) containing a carboxyl group or a salt of a carboxyl group is from 0.05 to 0.6 and is preferably in a range from 0.1 to 0.5. When the degree of substitution of the aromatic acyl group (B) containing a carboxyl group or a salt of a carboxyl group is less than 0.05, the cellulose mixed ester according to an embodiment of the present invention would fail to have intended hydrophilic performance. Such a cellulose mixed ester, when used as a semipermeable membrane, for example, would fail to provide sufficient fouling resistance, and thus this is not preferred. On the contrary, with the degree of substitution of the aromatic acyl group (B) of greater than 0.6, the cellulose mixed ester would have impaired alkali resistance, and thus this is not preferred.

The benzoyl group (A) that may include a substituent is a benzoyl group or a benzoyl group having at one or more of the ortho position, the meta position, or the para position one or more substituents, such as an alkyl group, such as a methyl group, a trifluoromethyl group, a tert-butyl group, and a phenyl group; an alkoxy group, such as a methoxy group and a phenoxy group; a hydroxy group; an amino group; an imino group; a halogeno group; a cyano group; and a nitro group. Among these substituents, one or more selected from a benzoyl group, a para-methylbenzoyl group, an ortho-methylbenzoyl group, a para-methoxybenzoyl group, an ortho-methoxybenzoyl group, and a dimethylbenzoyl group are preferred in terms of high chlorine resistance and high alkali resistance, as well as ease of availability.

The aromatic acyl group (B) containing a carboxyl group or a salt of a carboxyl group is preferably selected from aromatic acyl groups produced by a reaction of a hydroxy group of cellulose and an aromatic dicarboxylic monoanhydride that may include a substituent, such as phthalic anhydride that may include a substituent and a naphthalic anhydride that may include a substituent. Specific examples of the aromatic dicarboxylic monoanhydride include phthalic anhydride, 3-methylphthalic anhydride, 4-methylphthalic anhydride, 3-nitrophthalic anhydride, 4-ethoxycarbonyl-3,5-dimethylphthalic anhydride, 1,2-naphthalic anhydride, 1,8-naphthalic anhydride, 2,3-naphthalenedicarboxylic anhydride, 4-bromo-1,8-naphthalic anhydride, 2,3-anthracenedicarboxylic anhydride, and 2,3-pyridinedicarboxylic anhydride, and one or more of these aromatic dicarboxylic anhydrides can be used.

### Second Cellulose Mixed Ester

A second cellulose mixed ester according to an embodiment of the present invention is a cellulose mixed ester represented by a structural formula of General Formula (I) below.

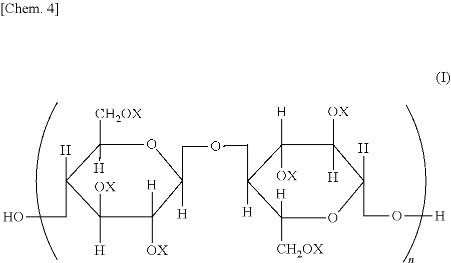

In General Formula (I), part of Xs are aromatic acyl groups, the remainder represents a hydrogen atom, and n represents an integer from 20 to 20000.

When X in the second cellulose mixed ester is an aromatic acyl group, a degree of substitution is from 1.8 to 2.9. The “degree of substitution” is an average value of the number of the aromatic acyl group added to three hydroxy groups in the glucose ring.

When X is a hydrogen atom, a degree of substitution corresponding to a hydroxyl group is from 0.1 to 1.2.

n represents an integer from 20 to 20000, preferably an integer from 40 to 10000, and more preferably an integer from 60 to 8000.

When X is an aromatic acyl group, the aromatic acyl group includes a benzoyl group (A) that may include a substituent, and an aromatic acyl group (B) containing a carboxyl group or a salt of a carboxyl group.

The degree of substitution of the benzoyl group (A) that may include a substituent is from 1.75 to 2.85. To improve the chlorine resistance and alkali resistance of the cellulose mixed ester according to an embodiment of the present invention, the benzoyl group (A) that may include a substituent preferably has higher degree of substitution.

The degree of substitution of the aromatic acyl group (B) containing a carboxyl group or a salt of a carboxyl group is from 0.05 to 0.6 and is preferably in a range from 0.1 to 0.5. When the degree of substitution of the aromatic acyl group (B) containing a carb oxyl group or a salt of a carboxyl group is less than 0.05, the cellulose mixed ester according to an embodiment of the present invention would fail to have intended hydrophilic performance. Such a cellulose mixed ester, when used as a semipermeable membrane, for example, would fail to provide sufficient fouling resistance, and thus this is not preferred. On the contrary, with the degree of substitution of the aromatic acyl group (B) of greater than 0.6, the cellulose mixed ester would have impaired alkali resistance, and thus this is not preferred.

The benzoyl group (A) that may include a substituent is a benzoyl group or a benzoyl group having at one or more of the ortho position, the meta position, or the para position one or more substituents, such as an alkyl group, such as a methyl group, a trifluoromethyl group, a tert-butyl group, and a phenyl group; an alkoxy group, such as a methoxy group and a phenoxy group; a hydroxy group; an amino group; an amino group; a halogeno group; a cyano group; and a nitro group. Among these substituents, one or more selected from a benzoyl group, a para-methylbenzoyl group, an ortho-methylbenzoyl group, a para-methoxybenzoyl group, an ortho-methoxybenzoyl group, and a dimethylbenzoyl group are preferred in terms of high chlorine resistance and high alkali resistance, as well as ease of availability.

The aromatic acyl group (B) containing a carboxyl group or a salt of a carboxyl group is preferably selected from aromatic acyl groups produced by a reaction of a hydroxy group of cellulose and an aromatic dicarboxylic monoanhydride that may include a substituent, such as phthalic anhydride that may include a substituent and naphthalic anhydride that may include a substituent. Specific examples of the aromatic dicarboxylic monoanhydride include phthalic anhydride, 3-methylphthalic anhydride, 4-methylphthalic anhydride, 3-nitrophthalic anhydride, 4-ethoxycarbonyl-3,5-dimethylphthalic anhydride, 1,2-naphthalic anhydride, 1,8-naphthalic anhydride, 2,3-naphthalenedicarboxylic anhydride, 4-bromo-1,8-naphthalic anhydride, 2,3-anthracenedicarboxylic anhydride, and 2,3-pyridinedicarboxylic anhydride, and one or more of these aromatic dicarboxylic anhydrides can be used.

When X is a hydrogen atom, a degree of substitution corresponding to a hydroxyl group is from 0.1 to 1.2. With the degree of substitution corresponding to a hydroxyl group of less than 0.1 when X is a hydrogen atom, the cellulose mixed ester according to an embodiment of the present invention would fail to have intended hydrophilic performance. Such a cellulose mixed ester, when used as a semipermeable membrane, for example, would fail to provide sufficient fouling resistance, and thus this is not preferred. On the contrary, with the degree of substitution of greater than 1.2, the cellulose mixed ester would have impaired chlorine resistance, and thus this is not preferred. When X is a hydrogen atom, the degree of substitution corresponding to a hydroxyl group is adjusted particularly by the proportion of the degree of substitution of the aromatic acyl group (B) containing a carboxyl group or a salt of a carboxyl group according to the function of the cellulose mixed ester according to an embodiment of the present invention.

### Molded Article

The first and second cellulose mixed esters according to an embodiment of the present invention can be formed into a molded article having a shape and a size according to the application. The molded article made of the first and second cellulose mixed esters according to an embodiment of the present invention is preferably selected from containers including a semipermeable membrane, a sheet, a foamed sheet, a tray, a pipe, a film, a fiber (filament), a non-woven fabric, and a bag.

The semipermeable membrane can be produced using the cellulose mixed ester, a solvent, and, as necessary, a membrane-forming solution containing a salt and a non-solvent.

Examples of the solvent may include N,N-dimethylformamide, N,N-dimethylacetamide, N,N-dimethyl sulfoxide (DMSO), and N-methyl-2-pyrrolidone (NMP), but N,N-dimethyl sulfoxide (DMSO) is preferred.

Examples of the non-solvent may include ethylene glycol, diethylene glycol, triethylene glycol, and polyethylene glycol.

Examples of the salt may include lithium chloride, sodium chloride, potassium chloride, magnesium chloride, and calcium chloride, but lithium chloride is preferred.

Regarding the concentrations of the first and second cellulose mixed esters and the solvent, preferably the concentration of the first and second cellulose mixed esters is from 10 to 35 mass %, and the solvent is from 65 to 90 mass %.

The salt is preferably from 0.5 to 2.0 mass % relative to 100 parts by mass of the total mass of the first and second cellulose mixed esters and the solvent.

The semipermeable membrane can be produced using the membrane-forming solution described above and using a well-known production method, for example, the production method described in Examples of JP 5418739 B. The semipermeable membrane is preferably a separation function membrane, such as a hollow fiber membrane, a reverse osmosis membrane, and a forward osmosis membrane, or a flat membrane.

The film can be produced by applying a method of casting the membrane-forming solution described above onto a substrate and then drying. The fiber (filament) can be produced using the membrane-forming solution described above and by applying a well-known wet spinning method or dry spinning method. The nonwoven fabric can be produced by a method of laminating fibers with an adhesive or a method of laminating fibers by heat fusing. Containers including a tray, a foamed sheet, and a bag can be produced by mixing the first and second cellulose mixed esters according to an embodiment of the present invention and, as necessary, a well-known additive for resins (such as a plasticizer), and then applying a well-known molding method, such as extrusion molding, blow molding, or injection molding.

### EXAMPLES

### Example 1: Production of First Cellulose Mixed Ester

In a round bottom flask equipped with a stirrer and a cooling tube, 900 g of an aqueous solution containing ammonia was placed, then 100 g of cellulose diacetate having an acetyl substitution degree of 2.44 was added, and the mixture was stirred at room temperature. After 24 hours, a solid was collected by suction filtration, and a wet cake containing cellulose was obtained. The resulting wet cake was placed in 300 g of N,N-dimethyl sulfoxide (DMSO), the mixture was stirred at room temperature for 1 hour, and a solid was collected again by suction filtration. This cellulose was then added to a solution prepared by dissolving 56 g of lithium chloride in 460 g of N,N-dimethylacetamide (DMAC), the mixture was stirred at 100° C., and the cellulose was dissolved.

After stirring, the above cellulose solution was placed in a round bottom flask equipped with a stirrer and a cooling tube, and stirring was started. While stirring was continued, benzoyl chloride corresponding to 85 mol % of a hydroxy group of the cellulose was added dropwise from a dropping funnel, then the temperature was raised to 80° C., and stirring was continued. Thereafter, a DMAC solution of phthalic anhydride corresponding to 20 mol % of a hydroxy group of the cellulose was added dropwise from a dropping funnel, and then stirring was continued. The resulting reaction mixture was cooled to room temperature, methanol was added while the mixture was stirred, and a precipitate was formed. The precipitate was collected by suction filtration, and a wet cake of crude cellulose benzoate phthalate was obtained. Ethanol was added to the resulting wet cake, and the wet cake was washed by stirring and dehydrated. This washing operation with ethanol was further repeated three times, and then the solvent was replaced with water. The mixture was dried with a hot air dryer, and the cellulose benzoate phthalate was obtained. The degree of substitution of the benzoyl group was 2.55, and the degree of substitution of the ortho-carboxylic benzoyl group was 0.45. The degree of substitution was determined by ¹H-NMR and ¹³C-NMR.

### Example 2: Hollow Fiber Membrane Made of Cellulose Mixed Ester of Example 1

A hollow fiber membrane (inner diameter/outer diameter=0.8/1.3 mm) was produced using the cellulose benzoate phthalate obtained in Example 1. Cellulose benzoate phthalate/DMSO/LiCl=21.0/78.0/1.0 (mass %) was used as a membrane-forming solution.

The membrane-forming method was as follows. The membrane-forming solution was sufficiently dissolved at 105° C. This solution was discharged from the outside of a double tube spinneret at 80° C., and concurrently water was discharged from an inner tube as an internal coagulation liquid. The membrane-forming solution was coagulated in a water bath at 50° C., and the solvent was sufficiently removed in a washing bath. The resulting hollow fiber membrane was stored in a wet state without drying moisture and measured for each item shown in Table 1. The results are shown in Table 1.

### Comparative Example 1

A hollow fiber membrane (inner diameter/outer diameter=0.8/1.3 mm) was produced using a cellulose acetate with an acetyl group substitution degree of 2.87 (available from Daicel Corporation). CTA/DMSO/LiCl=17.7/81.3/1.0 (mass %) was used as a membrane-forming solution.

The membrane-forming method was as follows. The membrane-forming solution was sufficiently dissolved at 105° C. This solution was discharged from the outside of a double tube spinneret at a pressure of 0.4 MPa and a discharge temperature of 95° C., and concurrently water was discharged from an inner tube as an internal coagulation liquid. The membrane-forming solution was passed through air and then coagulated in a water bath. The coagulated material was taken up at a speed of 6 m/min, and then the solvent was sufficiently removed in a washing bath. The resulting hollow fiber membrane was stored in a wet state without drying the moisture and measured for each item shown in Table 1. The results are shown in Table 1.

### Example 3: Production of Porous Filament

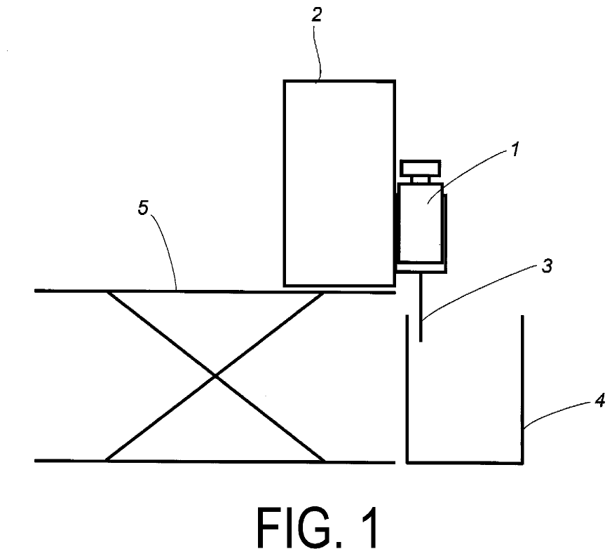

A porous filament was spun using the cellulose benzoate phthalate obtained in Example 1 and using an apparatus illustrated in FIG. 1. A predetermined amount of a solvent DMSO was charged to a round-bottom flask, and the cellulose benzoate phthalate was added in a mixing ratio of 20 mass % while the mixture was stirred with a three-one motor. Then the mixture was warmed with an oil bath and completely dissolved. The cellulose benzoate phthalate solution (dope) was transferred to a sample bottle, allowed to cool to room temperature and degassed. The dope was discharged (injection liquid 3) from a syringe 1 equipped at the tip with a nozzle with a bore diameter of about 0.5 mm using a syringe pump 2 to a mug 4 containing water at 25° C., and DMSO was replaced with water, and a porous filament with a diameter of 0.5 mm was obtained. The syringe pump 2 was supported with a lab jack 5. The resulting porous filament was stored in a wet state without drying the moisture and measured for each item shown in Table 2 below. The results are shown in Table 2.

### Comparative Example 2

A porous filament was spun in the same manner as in Example 3 using the cellulose acetate (available from Daicel Corporation) with the same acetyl group substitution degree of 2.87 as Comparative Example 1 and measured for each item shown in Table 2 below. The results are shown in Table 2.

### Chlorine Resistance Test

The hollow fiber membranes (inner diameter/outer diameter=0.8/1.3 mm, length of 1 m) from Example 2 and Comparative Example 1 or the porous filaments (diameter=0.5 mm, length of 10 cm) from Example 3 and Comparative Example 2, each 50 pieces, were used. An aqueous solution of sodium hypochlorite with an effective chlorine concentration of 12 mass % was diluted with pure water, and a test solution, an aqueous solution of 500 ppm or 1000 ppm sodium hypochlorite, was prepared. The effective chlorine concentration was measured using a Handy Water Meter AQUAB, Model AQ-102, available from Sibata Scientific Technology Ltd. Then, 50 hollow fiber membranes were immersed in 1 L of the test solution, the aqueous solution of 500 ppm or 1000 ppm sodium hypochlorite at about 25° C. contained in a plastic container with a lid, to be completely soaked in the test solution. The aqueous solution of 500 ppm or 1000 ppm sodium hypochlorite was newly prepared every 7 days, and the entire volume of the test solution was replaced. In addition, 10 hollow fibers were taken out of the plastic container with a lid every 7 days and washed with tap water, and then moisture was wiped off. The hollow fibers remaining in a wet state were measured for “tensile strength” and “elongation”.

### Alkali Resistance Test

The hollow fiber membranes (inner diameter/outer diameter=0.8/1.3 mm, length of 1 m) from Example 2 and Comparative Example 1 or the porous filaments (diameter=0.5 mm, length of 10 cm) from Example 3 and Comparative Example 2, each 50 pieces, were used. In 1 L of pure water, 10 g of NaOH pellets (purity of 97%) were dissolved, and the pH value was adjusted to 12.0 using phosphoric acid. Then, 50 porous filaments or 50 hollow fiber membranes were immersed in 1 L of a test solution, the alkaline aqueous solution with a pH value of 12.0 at 25° C. contained in a plastic container with a lid, to be completely soaked in the test solution. An alkaline aqueous solution with a pH value of 12.0 was newly prepared every 7 days, and the entire volume of the test solution was replaced. In addition, 5 porous filaments or 5 hollow fiber membranes were taken out of the plastic container with a lid at 2 hours, 8 hours, 24 hours, 96 hours, and 240 hours and washed with tap water, and then moisture was wiped off. The porous filaments or the hollow fiber membranes remaining in a wet state were measured for “tensile strength” and “elongation”.

### Measurements of “Tensile Strength” and “Elongation” and Determining Methods for Chlorine Resistance and Alkali Resistance

The porous filaments or the hollow fiber membranes in a wet state were clamped one by one with a distance between chucks being 5 cm using a compact tabletop tester (EZ-Test, available from Shimadzu Corporation), and measurement was carried out at a tensile speed of 20 mm/min. Based on the value of the “tensile strength” of the porous filament or the hollow fiber membrane immediately after immersed in the aqueous solution of 500 ppm or 1000 ppm sodium hypochlorite at 25° C. as the reference value, the time (days or hours) when the tensile strength value decreased below 90% of the reference value was obtained to determine a deteriorated state of the “tensile strength” measurement value for chlorine resistance. Based on the value of the “tensile strength” of the porous filament or the hollow fiber membrane immediately after immersed in the alkaline aqueous solution with a pH value of 12.0 at 25° C. as the reference value, the time (days or hours) when the tensile strength value decreased to below 90% of the reference value was obtained to determine a deteriorated state of the “tensile strength” measurement value for alkali resistance. Note that an average value from 3 pieces after excluding the highest and lowest values of the “tensile strength” measured for 5 pieces from the same sample was determined as the “tensile strength”. The results are shown in Table 1 and Table 2.

TABLE 1

| | | Orthocarboxylic | | | | | Alkali | Chlorine | Chlorine |
|---|---|---|---|---|---|---|---|---|---|
| | Benzoyl group (A) | benzoyl group (B) | Acetyl group | Hydroxy group | Tensile | | resistance | resistance | resistance |
| | substitution | substitution | substitution | substitution | strength | Elongation | pH 12 | 500 ppm | 1000 ppm |
| | degree | degree | degree | degree | [MPa] | [%] | [hours] | [days] | [days] |
| Example 2 | 2.55 | 0.45 | 0 | 0 | 6.1 | 8 | 96 or longer | 28 or longer | 14 or longer |
| Comparative | 0 | 0 | 2.87 | 0.13 | 5.1 | 26 | 5 | 6 | 3 |
| Example 1 | | | | | | | | | |

TABLE 2

| | | Alkali | Chlorine | Chlorine |
|---|---|---|---|---|
| | | resistance | resistance | resistance |
| | | pH 12 | 500 ppm | 1000 ppm |
| | | [hours] | [days] | [days] |
| Example 3 | Cellulose | 144 or longer | 42 or longer | 21 or longer |
| | benzoate | | | |
| | phthalate | | | |
| Comparative | Cellulose | 2 | 6 | 3 |
| Example 2 | triacetate | | | |

### INDUSTRIAL APPLICABILITY

The molded article made of the first cellulose mixed ester and the molded article made of the second cellulose mixed ester according to an embodiment of the present invention can be used as containers including a semipermeable membrane, a sheet, a foamed sheet, a tray, a pipe, a film, a fiber (filament), a non-woven fabric, and a bag.

1. A cellulose mixed ester represented by a structural formula of General Formula (I),
wherein when X is an aromatic acyl group, a degree of substitution is from 2.91 to 3.0;
the aromatic acyl group comprises a benzoyl group (A) that may comprise a substituent, and an aromatic acyl group (B) containing a carboxyl group or a salt of a carboxyl group;
when the degree of substitution is 3.0, a degree of substitution of the benzoyl group (A) that may comprise a substituent is from 2.4 to 2.95, and a degree of substitution of the aromatic acyl group (B) containing a carboxyl group or a salt of a carboxyl group is from 0.05 to 0.6; and 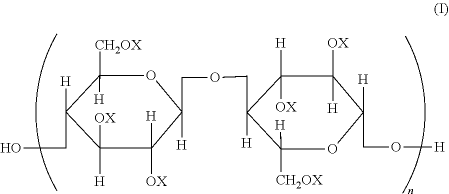
in General Formula (I), all or part of Xs are aromatic acyl groups; when part of Xs are aromatic acyl groups, the remainder represents a hydrogen atom or an alkyl group;
and n represents an integer from 20 to 20000.

2. A cellulose mixed ester represented by a structural formula of General Formula (I),
wherein when X is an aromatic acyl group, a degree of substitution is from 1.8 to 2.9;
the aromatic acyl group comprises a benzoyl group (A) that may comprise a substituent, and an aromatic acyl group (B) containing a carboxyl group or a salt of a carboxyl group;
a degree of substitution of the benzoyl group (A) that may comprise a substituent is from 1.75 to 2.85, and the degree of substitution of the aromatic acyl group (B) containing a carboxyl group or a salt of a carboxyl group is from 0.05 to 0.6;
when X is a hydrogen atom, a degree of substitution corresponding to a hydroxyl group is from 0.1 to 1.2; and 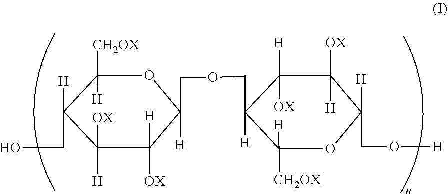
in General Formula (I), part of Xs are aromatic acyl groups, the remainder represents a hydrogen atom, and n represents an integer from 20 to 20000.

3. The cellulose mixed ester according to claim 1, wherein the benzoyl group (A) that may comprise a substitution group is selected from a benzoyl group, a para-methylbenzoyl group, an ortho-methylbenzoyl group, a para-methoxybenzoyl group, an ortho-methoxybenzoyl group, and a dimethylbenzoyl group; and the aromatic acyl group (B) containing a carboxyl group or a salt of a carboxyl group is selected from aromatic acyl groups produced by a reaction of a hydroxy group of cellulose and an aromatic dicarboxylic monoanhydride that may comprise a substituent.

4. A molded article comprising the cellulose mixed ester described in claim 1.

5. The cellulose mixed ester according to claim 2, wherein the benzoyl group (A) that may comprise a substitution group is selected from a benzoyl group, a para-methylbenzoyl group, an ortho-methylbenzoyl group, a para-methoxybenzoyl group, an ortho-methoxybenzoyl group, and a dimethylbenzoyl group; and the aromatic acyl group (B) containing a carboxyl group or a salt of a carboxyl group is selected from aromatic acyl groups produced by a reaction of a hydroxy group of cellulose and an aromatic dicarboxylic monoanhydride that may comprise a substituent.

6. A molded article comprising the cellulose mixed ester described in claim 2.

7. A molded article comprising the cellulose mixed ester described in claim 3.
